(19) United States
(12) Patent Application Publication
(10) Pub. No.: US 2018/0049592 A1
(43) Pub. Date: Feb. 22, 2018

(54) Kitchen Appliance for Processing Foodstuff

(71) Applicant: Hamilton Beach Brands, Inc., Glen Allen, VA (US)

(72) Inventors: Kristi Silvis, Glen Allen, VA (US); Koen Aidan Ambrose, Glen Allen, VA (US); Benjamin H. Branson, III, Mechanicsville, VA (US); Ernest B. Pryor, JR., Maidens, VA (US); David Matthew Schandel, Henrico, VA (US)

(21) Appl. No.: 15/240,626

(22) Filed: Aug. 18, 2016

(51) Int. Cl. A47J 43/046; A47J 43/07; A47J 43/08; B02C 23/16

(52) U.S. Cl. CPC A47J 43/046; A47J 43/0722; B02C 2023/165; B02C 23/16; A47J 43/085

(57) ABSTRACT

A kitchen appliance for processing foodstuff includes a housing, a bowl removably mounted onto the housing and defining a first cavity therein, and a removable lid to cover at least the bowl. A perforated basket is removably received between the bowl and the lid and defines a second cavity. A tool is removably coupleable with a drive shaft such that rotation of the drive shaft effectuates rotation of the tool. The tool is mountable in a first position on the drive shaft within the perforated basket, or in a second position on the drive shaft within the bowl. In the first position of the tool, apertures of the perforated basket permit foodstuff processed by the tool into fragments smaller than the apertures to pass from the second cavity into the first cavity. In the second position of the tool, foodstuff is processed by the tool directly in the first cavity.

### BACKGROUND OF THE DISCLOSURE

The present disclosure relates generally to a kitchen appliance for processing foodstuff and, more particularly, to a food processor or chopper that is capable of not over-processing, e.g., over-chopping, foodstuff.

Conventional food processors include a rotating blade that slices and chops foodstuff in a bowl with a removable lid covering the bowl and blade. Generally, when power is supplied to the food processor, a user must actively initiate the chopping process, e.g., press downwardly on the lid or activate a button/switch. Similarly, a user may also be required to stop the chopping process by performing another action, e.g., releasing the lid or otherwise disengaging the motor. One problem users may encounter is that by the time the user decides to stop operation of the food processor, the chopper may have already processed the foodstuff more than necessary or desired. Another problem a user may encounter is that in order to ensure that all of the foodstuff is properly processed, portions of the foodstuff may ultimately become over-processed.

Therefore, it would be advantageous to manufacture a food processor that is capable of not over-processing foodstuff more than a predetermined amount, irrespective of when the user stops operation thereof.

### BRIEF SUMMARY OF THE DISCLOSURE

Briefly stated, one aspect of the present disclosure is directed to a kitchen appliance for processing foodstuff. The kitchen appliance comprises a housing enclosing a motor, a bowl removably mounted onto the housing and defining a first cavity therein, and a removable lid to cover at least the bowl. A perforated basket is removably received between the bowl and the lid and defines a second cavity. A drive shaft is drivingly coupled with the motor to rotate relative to the housing, and extends through the first cavity and into the second cavity. A tool is removably coupleable with the drive shaft such that rotation of the drive shaft effectuates rotation of the tool. The tool is mountable in a first position on the drive shaft within the perforated basket, or mountable in a second position on the drive shaft within the bowl. In the first position of the tool, apertures of the perforated basket permit foodstuff processed by the tool into fragments smaller than the apertures to pass from the second cavity into the first cavity. In the second position of the tool, foodstuff is processed by the tool directly in the first cavity.

Another aspect of the present disclosure is directed to a kitchen appliance for processing foodstuff. The kitchen appliance comprises a housing enclosing a motor, a bowl removably mounted onto the housing and defining a first cavity therein, and a removable lid to cover at least the bowl. An apertured basket is removably received between the bowl and the lid, the basket having an apertured base end and an apertured skirt sidewall upwardly extending from the base end and defining a second cavity. A drive shaft is drivingly coupled with the motor to rotate relative to the housing, and extends through the first cavity and into the second cavity. A tool, mountable on the drive shaft within the apertured basket, is coupleable with the drive shaft such that rotation of the drive shaft effectuates rotation of the tool. Apertures of the apertured basket permit foodstuff processed by the tool into fragments smaller than the apertures to pass from the second cavity into the first cavity. The clearance between the base end or the sidewall of the basket and an adjacent wall of the appliance facing the base end or sidewall, respectively, is greater than or equal to a greatest dimension of the apertures.

### BRIEF DESCRIPTION OF THE DRAWINGS

The foregoing summary, as well as the following detailed description of the disclosure, will be better understood when read in conjunction with the appended drawings. For the purpose of illustrating the disclosure, there is shown in the drawings embodiments of a kitchen appliance which are presently preferred. It should be understood, however, that the disclosure is not limited to the precise arrangements and instrumentalities shown. In the drawings:

FIG. 1 is a front and side perspective view of a fully assembled configuration of a kitchen appliance according to a first preferred embodiment of the present disclosure;

FIG. 2 is a front and side perspective view of the kitchen appliance of FIG. 1, with a lid of the kitchen appliance removed;

FIG. 3 is a cross-sectional elevational view of the kitchen appliance of FIG. 1, taken along sectional line 3-3 of FIG. 2, with a rotational tool of the kitchen appliance in a first position thereof and the lid assembled;

FIG. 4 is a cross-sectional side elevational view of the kitchen appliance of FIG. 1, taken along sectional line 4-4 of FIG. 2, with the rotational tool in the first position thereof and the lid assembled;

FIG. 5 is a partial, cross-sectional side elevational view of the kitchen appliance of FIG. 1, taken along sectional line 3-3 of FIG. 2, with a basket of the kitchen appliance removed, the rotational tool in a second position thereof and the lid assembeled;

FIG. 6 is a bottom plan view of the rotational tool of the kitchen appliance of FIG. 1;

FIG. 7 is a perspective view of exemplary interlocking baskets for adjusting overall aperture size of the baskets;

FIG. 8 is a front and side perspective view of a kitchen appliance according to a second preferred embodiment of the present disclosure, with the lid removed;

FIG. 9 is a top plan view of the kitchen appliance of FIG. 8;

FIG. 10 is a cross-sectional side elevational view of the kitchen appliance of FIG. 8, taken along sectional line 10-10 of FIG. 8, with the rotational tool in the first position thereof and the basket and the lid assembled; and

FIG. 11 is a cross-sectional side elevational view of the kitchen appliance of FIG. 8, taken along sectional line 10-10 of FIG. 8, with the basket of the kitchen appliance removed, the rotational tool in a second position thereof and the lid assembled.

### DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the kitchen appliance, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

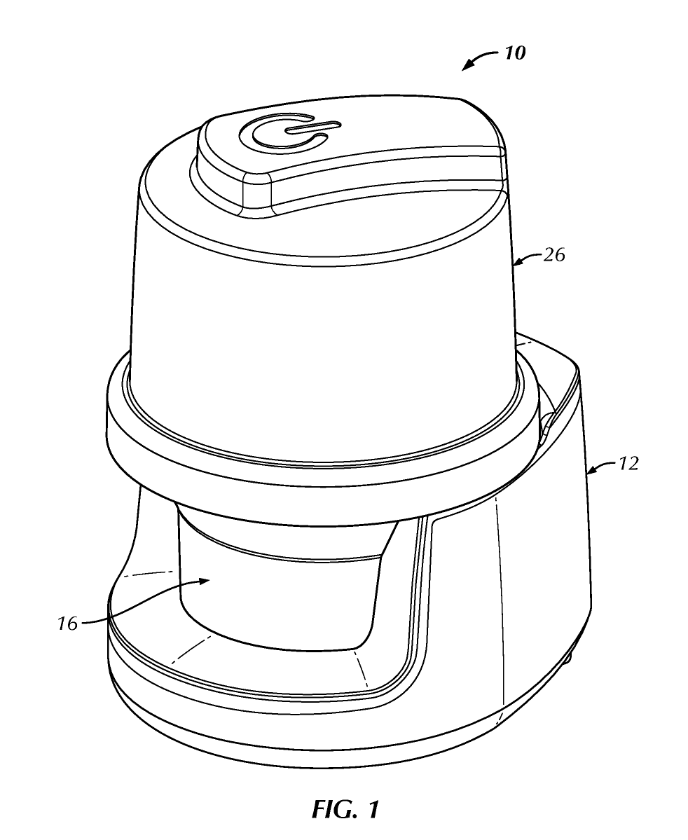

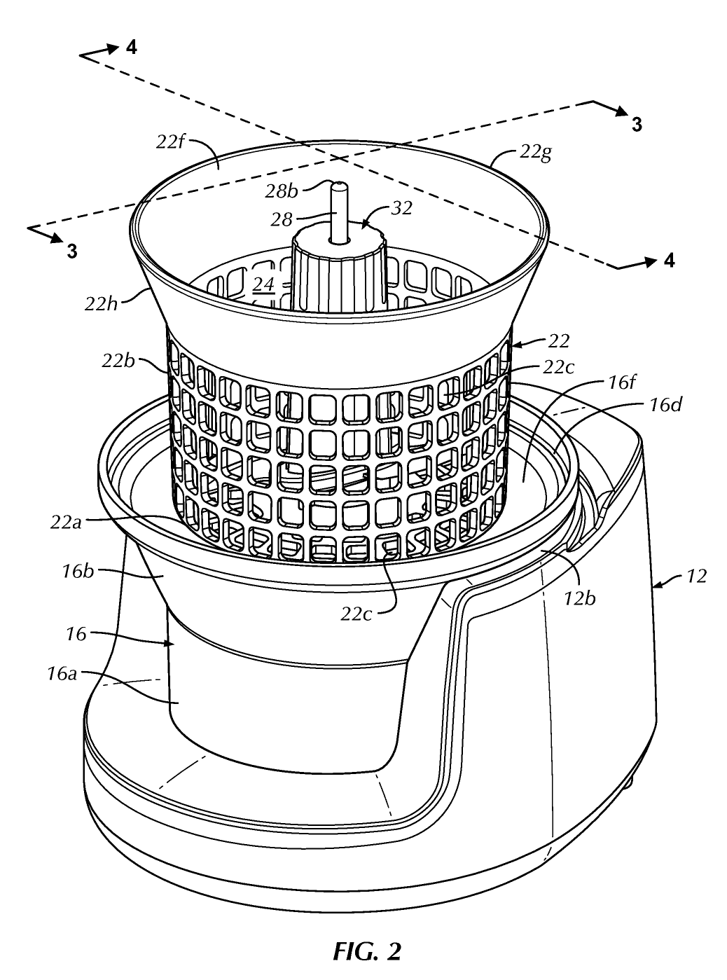

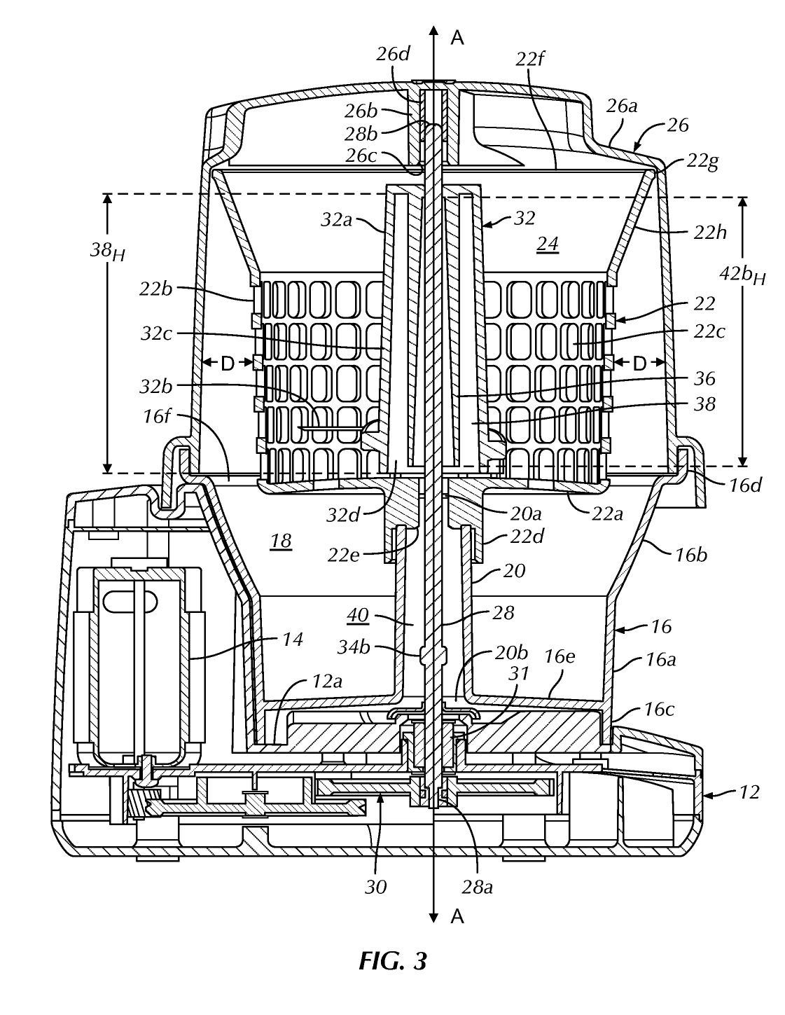

Referring to the drawings in detail, wherein like numerals indicate like elements throughout, there is shown in FIGS. 1-7 a kitchen appliance, generally designated 10, in accordance with a first embodiment of the present disclosure. The kitchen appliance 10 is intended or designed for, but not limited to, slicing, dicing, cutting, grinding, shredding, chopping, whipping, blending or otherwise mixing foodstuff (not shown), which will all be referred to herein in the aggregate as processing. Exemplary foodstuff includes, but is not limited to, meat(s), vegetables, soup, beverages, sauces and the like, or any combination thereof. In the illustrated embodiment, the kitchen appliance 10 is in the form of a food processor or chopper, but the kitchen appliance 10 may be any device, such as a blender, a combination coffee maker/grinder or the like, that includes at least two separable components. As shown in FIGS. 3-5, the kitchen appliance 10 defines a longitudinal axis A that extends at least generally, and preferably exactly, perpendicularly to an underlying support surface (not shown), such as a tabletop or countertop, when the kitchen appliance 10 is placed on the support surface.

As shown best in FIG. 3, the kitchen appliance 10 includes a housing 12 that at least partially encloses a motor 14. The motor 14 may be a one speed universal motor, but the present disclosure is not so limited. For example, the motor 14 may have multiple, distinct speeds that are selected by a user. Power may be supplied to the motor 14 from a conventional wall outlet (not shown) through a power cord (not shown). In the illustrated embodiment, an underside of the housing 12 is generally planar to rest substantially directly on an underlying support surface. Alternatively, however, the housing 12 may include spaced-apart feet extending downwardly from the underside of the housing 12 to support the kitchen appliance 10 on the support surface in a stable manner.

The housing 12 may be constructed of a polymeric material, such as an injection molded acrylonitrile butadiene styrene (ABS) material. The ABS material may be desirable due to its relatively smooth surface finish, its ability to readily take on various colors, its high impact and crack resistance, and its ability to be plated with a metallic finish. However, the housing 12 is not limited to polymeric or injected molded ABS materials, and may be constructed of nearly any generally rigid material that is able to take on the general shape of the housing 12 and perform the functionality of the housing 12 described herein. For example, the housing 12, and any other components of the kitchen appliance 10, may be constructed of a metallic or like material or combination of materials. The housing 12 may be generally or completely opaque, translucent or transparent.

A bowl 16 is removably mounted onto the housing 12. In the illustrated embodiment, the bowl 16 includes a generally frustoconical upper portion 16b atop a generally cylindrical lower portion 16a. The lower portion 16a includes a base wall 16e and an annular projection 16c projects downwardly therefrom. The projection 16c is received in a generally complementary annular channel 12a of the housing 12 when the bowl 16 is properly mounted onto the housing 12. The upper portion 16b includes a radially outwardly extending annular flange 16d at a top end thereof, which at least partially rests upon an upper rim 12b of the housing 12 when the bowl 16 is properly mounted onto the housing 12 such that the bowl 16 is stable when properly positioned on the housing 12. As should be understood by those of ordinary skill in the art, however, the bowl 16 may be removably mounted onto the housing 12 via any of numerous alternative methods currently known or that later become known. Optionally, the bowl 16 may include a handle (not shown) that extends radially outwardly from at least a portion of an exterior surface of the side wall of the bowl 16.

The bowl 16 may be constructed of a relatively rigid polymeric material, such as a molded styrene acrylonitrile (SAN) material. However, the bowl 16 is not limited to constructions using molded SAN material and may be constructed of nearly any polymeric, metallic, glass or like material that is able to form the desired shape(s) and withstand the normal operating conditions described herein. The bowl 16 may be generally or completely opaque, translucent or transparent.

The bowl 16 defines a first cavity 18 therein and the annular flange 16d defines a mouth 16f of the first cavity 18, opposite the base wall 16e. As shown in FIGS. 3-5, a column 20 extends upwardly, generally along the longitudinal axis A, from the base wall 16e of the bowl 16 and into the first cavity 18. In the illustrated embodiment, the column 20 is permanently and/or integrally formed (i.e., monolithic) with the bowl 16. As should be understood, however, the column 20 may alternatively be formed as a separate component from the bowl 16. The column includes an open top end 20a and an open bottom end 20b and is generally hollow therebetween.

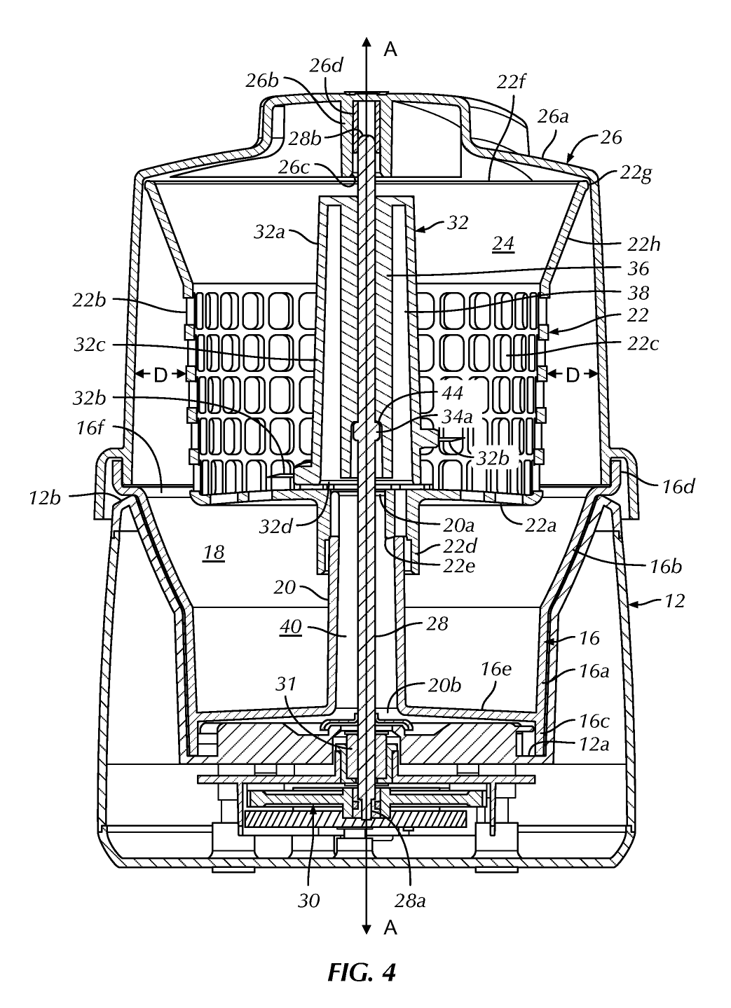

An apertured/perforated basket 22 is removably, axially supported in the kitchen appliance 10 by the column 20. In the illustrated embodiment, the basket 22 takes the form of a colander or a sieve. As should be understood by those of ordinary skill in the art, however, the basket 22 described herein encompasses any apertured, perforated or meshed structure that holds foodstuff greater than a predetermined size and allows foodstuff smaller than the predetermined size to pass therethrough and into the bowl 16. The illustrated basket 22 includes a base end 22a and a skirt sidewall 22b extending upwardly from the base end 22a and defining a second cavity 24 therebetween. A flared upper end 22h of the skirt sidewall 22b leads to an upper rim 22g of the basket 22, which defines a mouth 22f of the second cavity 24. The base end 22a and the sidewall 22b are both perforated with a plurality of apertures 22c of a predetermined size. In the illustrated embodiment, the apertures 22c are generally rectangular, but are not so limited, and may alternatively take the form of different shapes. As shown best in FIGS. 3 and 4, the basket 22 further includes a cylindrical neck 22d projecting downwardly from the base end 22a thereof.

When the basket 22 is properly positioned atop the column 20, the neck 22d is removably keyed with the upper end 20a of the column 20 to removably support the basket 22 atop the column 20 in a rotationally fixed manner, i.e., the basket 22 is prevented from rotating relative to the bowl 16. For example, the neck 22d may include a plurality of tabs 22e projecting radially inwardly from the neck 22d that removably slide into corresponding slots 20c extending axially downwardly from the upper end 20a of the column 20. Alternatively, the neck 22d may include slots (not shown) that engage tabs (not shown) of the column 20. As should be understood, however, the column 20 may removably, axially support the basket 22 via any of numerous different alternative methods.

Referring to FIGS. 1 and 3-5, a lid 26 is removably mountable onto the annular flange 16d at the top end of the bowl 16. When assembled, the lid 26 covers at least the bowl 16, and also covers the basket 22 when seated on the column 20, as shown. When the basket 22 is seated on the column 20 and the lid 26 is properly mounted onto the bowl 16, at least a portion of a top wall 26a of the lid 26 engages the upper rim 22g of the basket 22 to further stabilize the basket 22 atop the column 20.

As shown in FIGS. 3-5, a drive shaft 28 extends through the housing 12 generally along the longitudinal axis A. A bottom end 28a of the drive shaft 28 is drivingly coupled with the motor 14 in a conventional manner, to rotate relative to the housing 12 and about the longitudinal axis A. In the illustrated embodiment, the bottom end 28a of the drive shaft 28 is conventionally coupled to, and driven by, the motor 14 via a gear system 30, wherein, for example, the bottom end 28a of the drive shaft 28 is reverse threaded to a gear of the gear system 30, but the disclosure is not so limited. A bushing 31 supports and stabilizes the bottom end 28a of the drive shaft 28 for rotation. The drive shaft 28 axially extends upwardly through the column 20 and through the first cavity 18. When the basket 22 is positioned atop the column 20, the drive shaft 28 also extends through the second cavity 24.

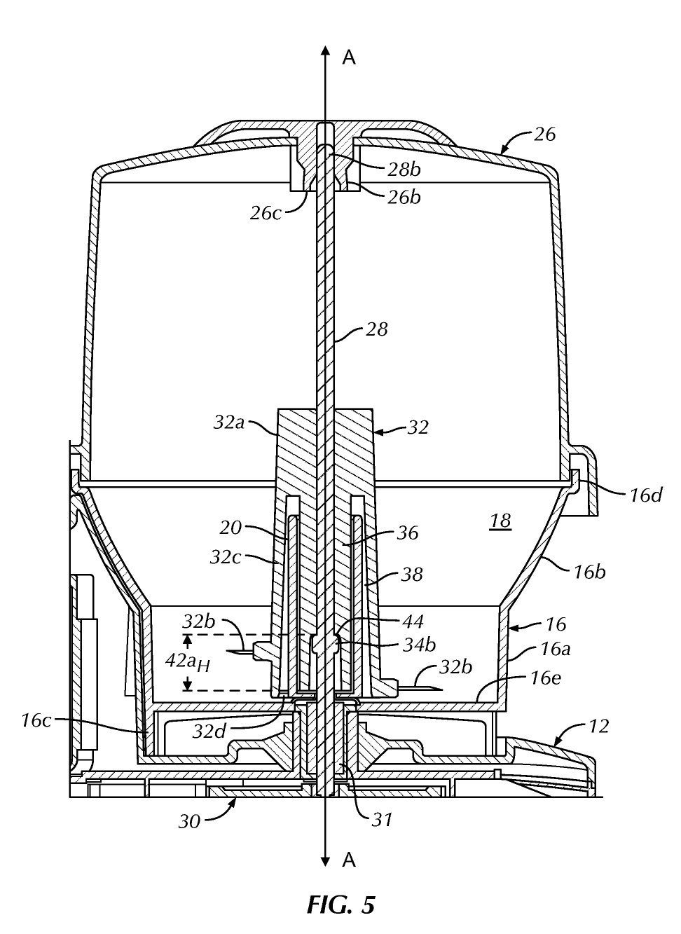

In the illustrated embodiment, an upper end 28b of the drive shaft 28 removably seats into an underside of the lid 26. As shown in FIGS. 3-5, the lid 26 includes a bushing 26b projecting downwardly from the lid 26. A base end 26c of the bushing 26b is chamfered and the upper end 28b of the drive shaft 28 is rounded. In one embodiment, as shown in FIG. 5, the upper end 28b of the drive shaft 28 is removably journaled directly into bushing 26b when the lid 26 is placed on the housing 12. The chamfered base end 26c of the bushing 26b and the rounded upper end 28b of the drive shaft 28 permit smooth engagement therebetween for rotation of the drive shaft 28. Advantageously, the chamfered/rounded engagement also facilitates aligning of the drive shaft 28 with the bushing 26b and, therefore, with the lid 26. Alternatively, as shown in FIGS. 3-4, the bushing 26b may include an inner bearing 26d into which the upper end 28b of the drive shaft 28 is removably journaled when the lid 26 is placed on the housing 12. Similarly to the base end 26c of the bushing 26b, the base end of the bearing 26d may also be chamfered, for smooth, facilitated engagement with the drive shaft 28 for rotation of the drive shaft 28.

The kitchen appliance 10 further includes at least one rotatable tool 32. As should be understood by those of ordinary skill in the art, the kitchen appliance may optionally include two or more separate and distinct rotatable tools or cutting mechanisms (none shown). In the illustrated embodiment, the tool 32 is a chopping tool, such as, for example, without limitation, a slicing or S-blade. As should be understood, however, the rotatable tool 32 may have many alternative forms or shapes, such as, for example, without limitation, a generally flat or planar shredding blade.

The rotatable tool 32 is removably coupleable with the drive shaft 28 such that rotation of the drive shaft 28 about the longitudinal axis A effectuates rotation of the tool 32. In the illustrated embodiment, the rotatable tool 32 includes a tool spindle 32a, which is removably keyed to the drive shaft 28 (as will be described in further detail below) and two or more blades 32b projecting laterally (or radially) outwardly from the tool spindle 32a.

As shown best in FIGS. 3-5, the drive shaft 28 includes at least one upper tooth 34a (FIG. 4) projecting laterally (or radially) outwardly from the drive shaft 28 and at least one lower tooth 34b (FIGS. 3, 5), spaced axially downwardly from the at least one upper tooth 34a, and also projecting laterally (or radially) outwardly from the drive shaft 28. In the illustrated embodiment, a pair of diametrically opposed upper teeth 34a project laterally (or radially) outwardly from the drive shaft 28 and a pair of diametrically opposed lower teeth 34b project laterally (or radially) outwardly from the drive shaft 28, but the disclosure is not so limited. In the illustrated embodiment, the upper teeth 34a and the lower teeth 34a extend in the parallel planes, substantially perpendicularly to one another, but the disclosure is also not so limited. As should be understood, more than two upper teeth 34a or lower teeth 34b may be employed, and, for example, an unequal number of upper teeth 34a and lower teeth 34b may also be employed. Furthermore, where a plurality of upper teeth 34a or lower teeth 34b are employed, they need not be diametrically opposed.

The rotatable tool 32 is mountable in a first position (FIGS. 3, 4), wherein the tool spindle 32a is keyed to the upper teeth 34a, and also mountable in a second position (FIG. 5), wherein the tool spindle 32a is keyed to the lower teeth 34b. The upper teeth 34a are axially positioned along the drive shaft 28, such that when the basket 22 is properly mounted on the column 20, the upper teeth 34a are located within the basket 22. Accordingly, when the basket 22 is mounted on the column 20 and the rotatable tool 32 is mounted in the first position, the rotatable tool 32 is also located for rotation within the basket 22. The lower teeth 34b are axially positioned along the drive shaft 28, such that when the bowl 16 is properly mounted on the housing 12 without the basket 22 (see FIG. 5), the lower teeth 34b are located within the bowl 16. Therefore, when the basket 22 is removed and the rotatable tool 32 is mountable in the second position, the rotatable tool 32 is located for rotation within the bowl 16.

As shown in FIGS. 3-5, the tool spindle 32a includes an internal, generally cylindrical, axially extending tool hub 36. A first, generally annular channel 38 is defined between the inner tool hub 36 and an outer, annular wall 32c of the tool spindle 32a. The channel 38 defines an axial extent 38_{H} (FIG. 3) extending upwardly from an open base end 32d of the tool spindle 32a. In the illustrated embodiment, the axial extent 38_{H} of the first channel 38 extends substantially toward the upper end of the tool spindle 32a, but the disclosure is not so limited.

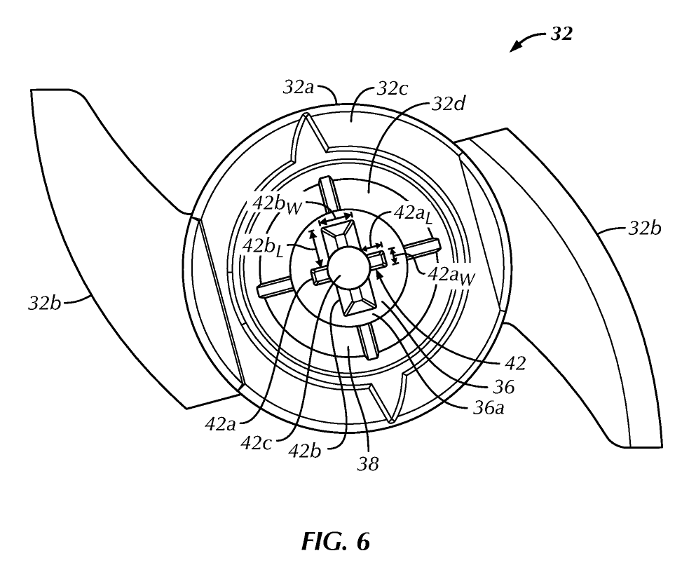

Turning to FIG. 6, the tool hub 36 has a generally cruciform shaped slot 42 in a base end 36a thereof. The slot 42 includes a first laterally extending slot 42a and a second laterally extending slot 42b oriented substantially perpendicularly to the first slot 42a. The first slot 42a defines an upward axial extent 42a_{H} (FIG. 5) extending from the base end 36a, a length 42a_{L} and a width 42a_{w} (FIG. 6). Likewise, the second slot 42b defines an upward axial extent 42b_{H} (FIG. 3) extending from the base end 36a, a length 42b_{L} and a width 42b_{w}. A second axially extending channel 42c is positioned at the intersection of the first slot 42a and the second slot 42b and extends entirely through the tool hub 36 and tool spindle 32a to slidably receive the drive shaft 28 therethrough.

To mount the rotatable tool 32 in the first position thereof, i.e., key the rotatable tool 32 with the upper teeth 34a, the lid 26 is removed and the base end 32d of the tool spindle 32 is engaged with the upper end 28b of the drive shaft 28 (with the basket 22 in place on the column 20). The rotatable tool 32 is advanced axially downwardly, with the drive shaft 28 slidably advancing upwardly through the second axially extending channel 42c of the tool hub 36. The rotatable tool 32 is manually rotated about the drive shaft 28 to align the upper teeth 34a with the first slot 42a. The length 42a_{L} and a width 42a_{w} of the first slot 42a are dimensioned to complementarily engage, e.g., substantially fittingly receive, the diametrically opposed upper teeth 34a. An upper end (of the axial extent 42a_{H}) of the first slot 42a defines a shoulder 44 (FIG. 4).

In the illustrated embodiment, the axial extent 42a_{H} of the first slot 42a is dimensioned such that the shoulder 44 rests on the upper teeth 34a, to axially support the rotatable tool 32 in the first position thereof. Therefore, the drive shaft 28 is slidably advanced through the second axially extending channel 42c of the tool hub 36 until abutment of the shoulder 44 with the upper teeth 34a. As should be understood, however, the axial extent 42a_{H} of the first slot 42a may alternatively be dimensioned so that the shoulder 44 does not engage the upper teeth 34a, but rather permits the drive shaft 28 to slidably advance through the second axially extending channel 42c of the tool hub 36 until the base end 32d of the tool spindle 32a rests against, and is axially supported by, the base end 22a of the basket 22. The lid 26 is then re-positioned atop the bowl 16 and the basket 22, with the upper end 28b of the drive shaft 28 journaling into the bushing 26b, for use of the kitchen appliance 10.

To mount the rotatable tool 32 in the second position thereof, i.e., key the rotatable tool 32 with the lower teeth 34b, the lid 26 is removed and the basket 22 is also removed, i.e., withdrawn from engagement with the column 20. The rotatable tool 32 is then mounted on the column 20. As shown best in FIG. 5, the rotatable tool 32 is aligned such that the column 20 is axially, slidably advanced through the first annular channel 38, via the open end 32d thereof, to mount the rotatable tool 32 onto the column 20, and the drive shaft 28 is axially, slidable advanced through the second channel 42c. A gap or spacing 40 (FIGS. 3, 4) separates the column 20 from the drive shaft 28 so as to receive at least a portion of the tool hub 36 (FIG. 5). The tool spindle 32a is, therefore, sized and/or shaped to fit over the column 20 in the bowl 16 and engage the drive shaft 28.

The first slot 42a complementarily receives the lower teeth 34b in the second position of the rotatable tool 32. That is, the length 42a_{L} and width 42a_{w} of the first slot 42a are also dimensioned to complementarily engage, e.g., substantially fittingly receive, the diametrically opposed lower teeth 34b. Because the lower teeth 34b are oriented perpendicularly to the upper teeth 34a, the rotatable tool 32 must be manually rotated 90° about the drive shaft 28, i.e., about the longitudinal axis A, from the orientation of the rotatable tool 32 in the first position to align the first slot 42a with the lower teeth 34b.

Upon rotation of the rotatable tool 32 to align the first slot 42a with the lower teeth 34b, the second slot 42b, which is perpendicular to the first slot 42a, aligns with the upper teeth 34a. The length 42b_{L} and width 42b_{w} of the second slot 42b are dimensioned to receive the diametrically opposed upper teeth 34a. In one embodiment, the length 42b_{L} and width 42b_{w} of the second slot 42b are dimensioned to substantially fittingly receive the diametrically opposed upper teeth 34a, but the disclosure is not so limited. Alternatively, the length 42b_{L} and width 42b_{w} of the second slot 42b may be dimensioned to loosely receive the upper teeth 34a.

Upon aligning the first slot 42a with the lower teeth 34b and the second slot 42b with the upper teeth 34a (which occurs simultaneously), the rotatable tool 32 is advanced axially downwardly, with the drive shaft 28 slidably advancing upwardly through the second axially extending channel 42c of the tool hub 36. Upon slidably passing the upper teeth 34a, the upper teeth 34a are axially slidably advanced through the second slot 42b. The axial extent 42b_{H} of the second slot 42b is dimensioned to provide sufficient clearance for sliding the upper teeth 34a therethrough to properly position the rotatable tool 32 in the second position thereof.

In the illustrated embodiment, the rotatable tool 32 is advanced axially downwardly until the shoulder 44 rests on the lower teeth 34b, to axially support the rotatable tool 32 in the second position thereof. As indicated above, however, the axial extent 42a_{H} of the first slot 42a may alternatively be dimensioned so that the shoulder 44 does not engage the lower teeth 34b, but rather permits the drive shaft 28 to slidably advance through the second axially extending channel 42c of the tool hub 36 until the base end 32d of the tool spindle 32a rests against, and is axially supported by, the base wall 16e of the bowl 16. The lid 26 is then re-positioned atop the bowl 16, without the basket 22, and with the upper end 28b of the drive shaft 28 journaling into the bushing 26b, for use of the kitchen appliance 10.

The kitchen appliance 10 is generally operated in a conventional manner, as should be understood by those of ordinary skill in the art. For example, without limitation, a switch mechanism (not shown) may be operably connected to the motor 14 to actuate or permit actuation of the motor 14. The switch mechanism may include a first, open/disengaged position, wherein the power circuit to the motor is interrupted, and, therefore, power from the power supply (wall outlet) does not reach the motor 14, and a second, closed/engaged position, wherein the power circuit is connected, such that the power from the power supply reaches the motor 14. The switch mechanism is normally oriented, e.g., biased, in the disengaged position, thereby acting as a safety interlock feature of the kitchen appliance 10, such that the motor 14 cannot be actuated unless certain components of the kitchen appliance 10 are properly assembled and/or configured.

For example, without limitation, when the lid 26 is properly mounted onto bowl 16, the motor 14 may be actuated or permitted to be actuated by pressing downwardly on the lid 26, such that the switch is manually actuated from the disengaged position to the engaged position, in a manner well understood by those of ordinary skill in the art. Therefore, if the bowl 16 is not properly attached to the housing 12, and/or the lid 26 is not properly attached to the bowl 16, the motor 14 cannot be actuated.

When the basket 22 is properly positioned on the column 20, and the rotatable tool 32 is properly positioned in the first position thereof, as described above, foodstuff to be processed is placed in the second cavity 24 of the basket 22. After the lid 26 is properly positioned to cover the basket 22 and the bowl 16, and power is supplied to the motor 14, the motor 14 effectuates rotation of the drive shaft 28 about the longitudinal axis A, and the keyed engagement between the upper teeth 34a and the tool spindle 32a, as explained above, effectuates rotation of the rotatable tool 32 about the longitudinal axis A to process the foodstuff within the basket 22.

The apertures 22c of the basket 22 permit foodstuff processed by the rotatable tool 32 into fragments that are smaller than the apertures 22c to pass from the second cavity 24 of the basket 22 into the first cavity 18 of the bowl 16 through the apertures 22c. With the rotating tool 32 in the second cavity 24, the foodstuff fragments that pass through the apertures 22c and fall into the first cavity 18 are no longer in contact with the rotating tool 32 and, therefore, are not further processed thereby. Advantageously, foodstuff is, therefore, only processed until reduced to fragments that may pass through the apertures 22c. Accordingly, the foodstuff is generally not over-processed into a size substantially smaller than the apertures 22c, regardless of how long the rotatable tool 32 is actuated.

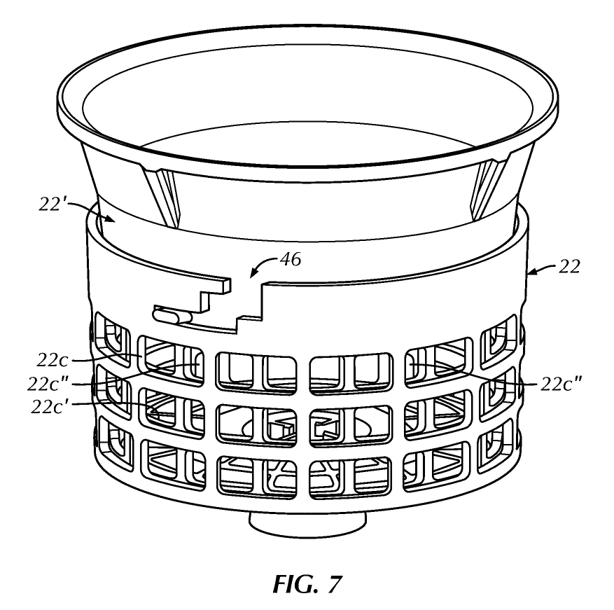

As should be understood by those of ordinary skill in the art, the size of the apertures 22c of the basket 22 may be adjustably dimensioned in order to select an appropriate, or user-desired, aperture size for the foodstuff being processed. For example, without limitation, a user may select one of multiple baskets 22 for use, each having differently sized/shaped and/or differently oriented apertures 22c. As another example, without limitation, interlocking baskets 22 and 22′ may be utilized, as shown in FIG. 7, each basket 22 and 22′ having differently sized and/or differently oriented apertures. The outer basket 22, for example, may have larger apertures 22c, whereas the inner basket 22′ may have smaller apertures 22c′ or merely differently oriented apertures 22c′. For example, the apertures 22c′ may be out of phase with the apertures 22c when the baskets 22 and 22′ are overlapped. The baskets 22 and 22′ may be telescopically oriented and releasably interlocked together, e.g., via a bayonet style connection 46 as illustrated. As shown, the connection 46 may include multiple levels, corresponding to multiple degrees of aperture overlap between the two baskets 22 and 22′. The overlap of the apertures 22c and 22c′ results in varied degrees of smaller sized openings 22c″ for foodstuff to pass through. As should be understood by those of ordinary skill in the art, however, the apertures 22c may be adjustably dimensioned via any of numerous different methods, currently known or that later become known, and the disclosure is not limited to the exemplary embodiment of FIG. 7.

Also with respect to the apertures 22c, the clearance between the base end 22a or the sidewall 22b of basket 22, i.e., any portion of the sidewall 22b having apertures 22c therein, and an adjacent wall of the kitchen appliance 10 facing the base end 22a or sidewall 22b, respectively, is greater than or equal to a greatest dimension of the apertures 22c. For example, as shown best in FIGS. 3 and 4, the distance D between the sidewall 22b of the basket 22 and the lid 26 is greater than the greatest dimension of any aperture 22c. Advantageously, such clearance prevents foodstuff fragments that pass through any aperture 22c from becoming lodged in between the basket 22 and the adjacent structure of the kitchen appliance 10, and helps to ensure that foodstuff fragments passing through the apertures 22c have a substantially unobstructed path down to the first cavity 18.

When a user prefers to utilize the kitchen appliance 10 in a conventional manner, i.e., without the basket 22, the user removes the lid 26, withdraws the rotatable tool 32 from engagement with the drive shaft 28 and removes the basket 22 from atop the column 20 as explained above. As also explained above, the user may thereafter re-engage the rotatable tool 32 with the drive shaft 28 and position the rotatable tool 32 in the second position thereof (FIG. 5). After the lid 26 is re-positioned atop the bowl 16, the kitchen appliance 10 may be used in a conventional manner, wherein the foodstuff is processed by the rotatable tool 32 directly in the first cavity 18.

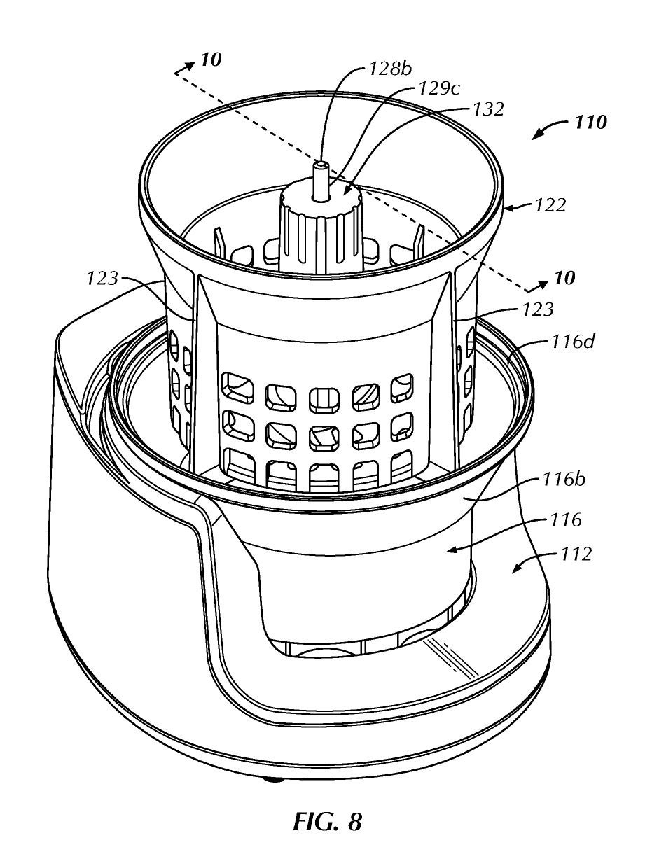

FIGS. 8-11 illustrate a second embodiment of the kitchen appliance 110. The reference numerals of the present embodiment are distinguishable from those of the above-described first embodiment (FIGS. 1-7) by a factor of one-hundred (100), but otherwise indicate the same elements as indicated above, except as otherwise specified. The kitchen appliance 110 of the present embodiment is substantially similar to that of the earlier embodiment. Therefore, the description of certain similarities and modes of operation between the embodiments may be omitted herein for the sake of brevity and convenience, and, therefore, is not limiting.

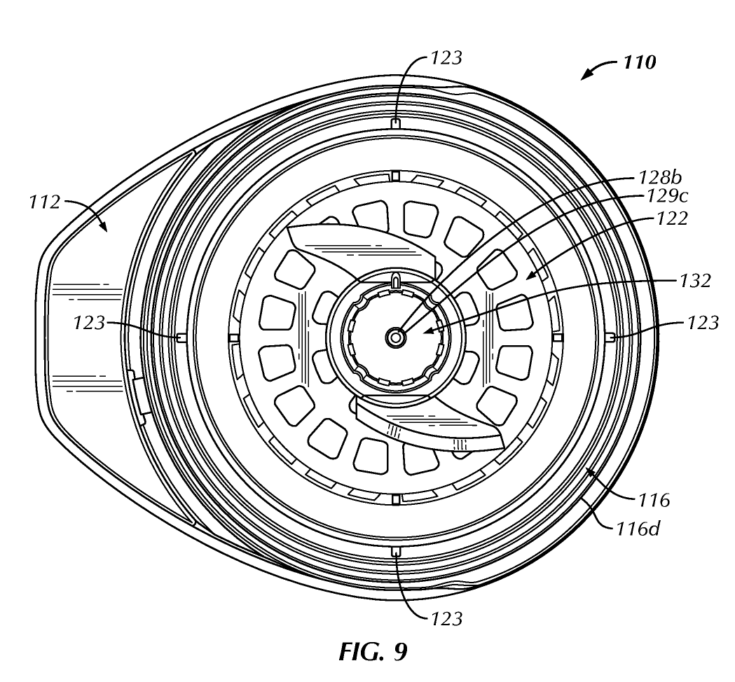

One difference over the embodiment of FIGS. 1-7, as shown best in FIGS. 8 and 9, is that the apertured/perforated basket 122 includes a plurality of angularly spaced apart, axially extending ribs 123, projecting radially outwardly from the basket 122 to support the basket 122 atop the bowl 116. The ribs 123 are sized and dimensioned such that the bottom ends of the ribs 123 abut the frustoconical upper portion 116b of the bowl 116 to support the basket 122 atop the bowl 116. In the illustrated embodiment, the basket 122 includes four (4) ribs 123 angularly spaced approximately 90° apart from one another to support the basket 122 atop the bowl 116 in a stable manner, maintaining the basket 122 properly leveled. As should be understood by those of ordinary skill in the art, however, the basket 122 can include more or less ribs 123 preferably generally equally angularly spaced apart, to support the basket 122 atop the bowl 116 in a stable and level manner. As also should be understood, the ribs 123 may be sized and dimensioned to abut the radially outwardly extending annular flange 116d at a top end of the upper portion 116b. In the illustrated embodiment, frictional engagement between the ribs 123 and the bowl 116 substantially prevents the basket 122 from rotating. Alternatively, however, the bowl 116 may include slots or the like, corresponding to the ribs 123 and for engagement therewith, for further preventing rotation of the basket 122.

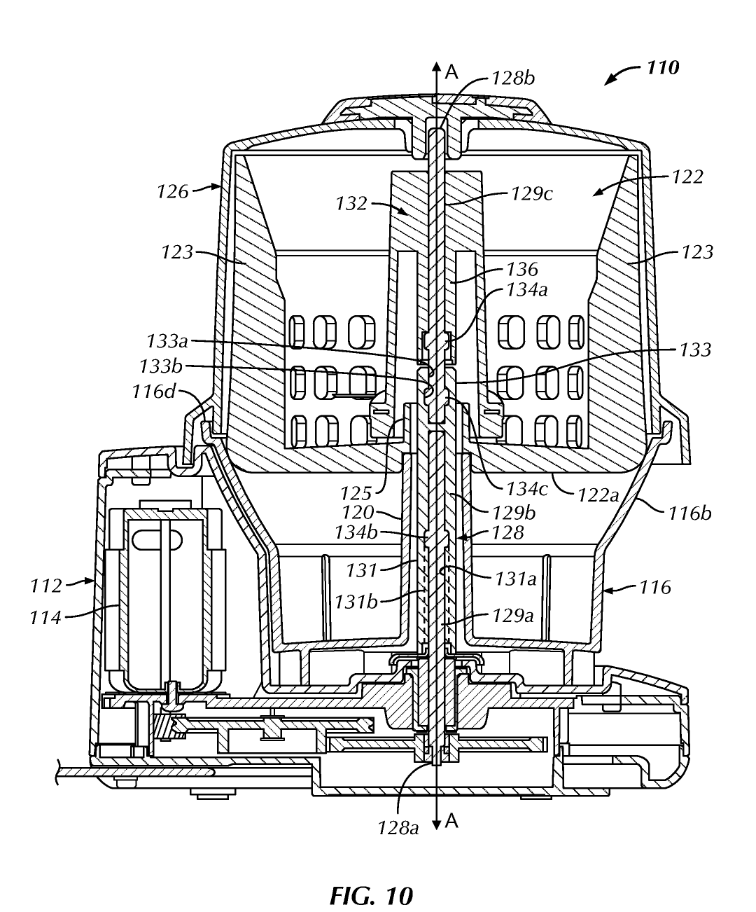

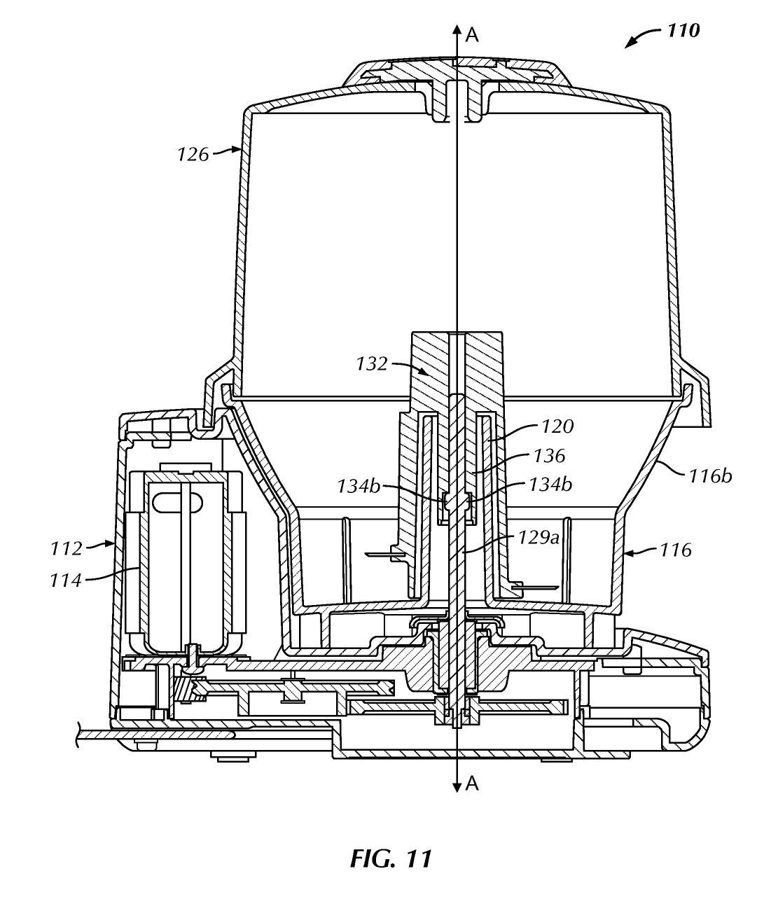

Turning to FIGS. 10 and 11, another difference over the embodiment of FIGS. 1-7 pertains to the drive shaft. The drive shaft 128, in the present embodiment, is comprised of a first drive shaft portion 129a, a shaft adapter 129b, and a second drive shaft portion 129c. The shaft adapter 129b is removably slidable atop the first drive shaft portion 129a, and the second drive shaft portion 129c is rotationally fixedly secured to the shaft adapter 129b, as will be described in further detail below. The bottom end 128a of the first drive shaft portion 129b is drivingly coupled with the motor 114 in a conventional manner (as explained with respect to the embodiment of FIGS. 1-7), to rotate relative to the housing 112 and about the longitudinal axis A.

The first drive shaft portion 129a extends axially upwardly through the column 120 approximately to the flange 116d of the bowl 116. Similar to the embodiment of FIGS. 1-7, the first drive shaft portion 129a includes at least one lower tooth 134b projecting laterally (or radially) outwardly therefrom. In the illustrated embodiment, a pair of diametrically opposed lower teeth 134b project laterally (or radially) outwardly from the first drive shaft portion 129a, but the disclosure is not so limited. As shown in FIG. 11, the rotatable tool 132 is mounted onto the first drive shaft portion 129a in the second position of the tool 132 (with the perforated basket 122 removed) in a rotationally fixed manner as explained with respect to the embodiment of FIGS. 1-7 (generally, the tool hub 136 of the rotatable tool 132 is keyed with the lower teeth 134b).

To mount the rotatable tool 132 in the first position thereof (within the perforated basket 122), however, the shaft adapter 129b is removably attached to the first drive shaft portion 129a in a rotationally fixed, male-female engagement. As shown in FIG. 10, the shaft adapter 129b includes a lower portion 131 defining a lower channel 131a therein and an upper portion 133 defining an upper channel 133a therein. The lower channel 131a in the lower portion 131 is sized and dimensioned to slidably receive the first drive shaft portion 129a therein. The lower portion 131 also includes a laterally extending slot 131b having an upward axial extent extending from the base end of the shaft adapter 129b to slidably receive the lower teeth 134b of the first drive shaft portion 129a. To slide the shaft adapter 129b onto the first drive shaft portion 129a, the slot 131b is aligned with the lower teeth 134b in order to advance the first drive shaft portion 129a and the lower teeth 134b through the lower channel 131 and the slot 131b, respectively, in a rotationally fixed manner.

The second drive shaft portion 129c is rotationally fixedly secured to the shaft adapter 129b. As shown in FIG. 10, the second drive shaft portion 129c includes at least one adapter tooth 134c projecting laterally (or radially) outwardly therefrom and at least one upper tooth 134a projecting laterally (or radially) outwardly therefrom and spaced upwardly from the at least one adapter tooth 134c. In the illustrated embodiment, a pair of diametrically opposed upper teeth 134a and a pair of diametrically opposed adapter teeth 134c project laterally (or radially) outwardly from the second drive shaft portion 129c, but the disclosure is not so limited.

A bottom portion of the second drive shaft portion 129c is fixedly secured in the upper channel 133a of the upper portion 133 of the shaft adapter 129b and the adapter teeth 134c are fittingly received within corresponding slots 133b in the upper portion 133 in a manner well understood by those of ordinary skill in the art to rotationally fix the second drive shaft portion 129c to the shaft adapter 129b. As should be understood by those of ordinary skill in the art, however, the second drive shaft portion 129c may be fixedly secured to the shaft adapter 129b via any of numerous methods currently known or that later become known, or, alternatively, the second drive shaft portion 129c may be integrally constructed with the shaft adapter 129b, i.e., the second drive shaft portion 129c and the shaft adapter 129b being a monolithic unit. Yet alternatively, the second drive shaft portion 129c may be rotationally fixedly removably attachable to the shaft adapter 129b in a like manner as the first drive shaft portion 129a.

In operation, when the shaft adapter 129b is mounted onto the first drive shaft portion 129a (as explained above) and the perforated basket 122 is supported atop the bowl 116, the shaft adapter 129b and attached second drive shaft portion 129c extend into and through the perforated basket 122 through a channel 125 of the perforated basket 122, extending upwardly from the base end 122a thereof. As shown in FIG. 10, the rotatable tool 132 is mounted onto the second drive shaft portion 129c in the first position of the tool 132 in a rotationally fixed manner in a like manner as explained with respect to the embodiment of FIGS. 1-7 (generally, the tool hub 136 of the rotatable tool 132 is keyed with the upper teeth 134a. The upper end 128b of the second drive shaft portion 129c removably seats into an underside of the lid 126, in like manner as explained with respect to the embodiment of FIGS. 1-7.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

We claim:

1. A kitchen appliance for processing foodstuff comprising:
a housing enclosing a motor;
a bowl removably mounted onto the housing and defining a first cavity therein;
a removable lid to cover at least the bowl;
a perforated basket removably received between the bowl and the lid and defining a second cavity,
a drive shaft drivingly coupled with the motor to rotate relative to the housing, the drive shaft extending through the first cavity and extendable into the second cavity;
a tool removably coupleable with the drive shaft such that rotation of the drive shaft effectuates rotation of the tool, the tool being mountable in a first position on the drive shaft within the perforated basket, or mountable in a second position on the drive shaft within the bowl; and
wherein, in the first position of the tool, apertures of the perforated basket permit foodstuff processed by the tool into fragments smaller than the apertures to pass from the second cavity into the first cavity, and in the second position of the tool, foodstuff is processed by the tool directly in the first cavity.

2. The kitchen appliance of claim 1, further comprising an elongate column extending upwardly in the first cavity, the drive shaft extending through the elongate column, and wherein the perforated basket includes a neck projecting downwardly from a base end thereof, the neck being removably keyed with an upper end of the column to removably secure the perforated basket atop the column.

3. The kitchen appliance of claim 1, wherein the perforated basket includes a plurality of angularly spaced apart ribs projecting radially outwardly therefrom, the ribs being dimensioned to engage the underlying bowl to removably support the basket atop the bowl when the perforated basket is received between the bowl and the lid.

4. The kitchen appliance of claim 1, wherein the drive shaft comprises a first drive shaft portion, a shaft adapter and a second drive shaft portion, the shaft adapter and the second drive shaft portion being removably mountable onto the first drive shaft portion and rotationally fixed therewith.

5. The kitchen appliance of claim 1, wherein the drive shaft includes at least one upper tooth laterally projecting from the drive shaft and at least one lower tooth axially spaced downwardly from the at least one upper tooth and laterally projecting from the drive shaft, and wherein the tool includes a tool spindle removably mountable on the drive shaft, the tool spindle being keyed to the at least one upper tooth in the first position of the tool and the tool spindle being keyed to the at least one lower tooth in the second position of the tool.

6. The kitchen appliance of claim 5, wherein the at least one upper tooth comprises a pair of diametrically opposed upper teeth and the at least one lower tooth comprises a pair of diametrically opposed lower teeth, the upper teeth being oriented substantially perpendicular to the lower teeth.

7. The kitchen appliance of claim 5, wherein the tool spindle comprises a generally central, axially extending tool hub having a generally cruciform shaped slot in a base end thereof, the cruciform slot comprising a first laterally extending slot and a second laterally extending slot oriented generally perpendicularly to the first slot, the first and second slots each defining a respective upward axial extent into the tool hub, a respective length of the lateral projection thereof, and a respective width thereof; and
wherein the tool hub further comprises an axially extending channel positioned at an intersection of the first and second slots, the channel extending entirely through the tool hub for receiving the drive shaft therethrough.

8. The kitchen appliance of claim 7, wherein the first slot receives the diametrically opposed upper teeth in the first position of the tool and the first slot receives the diametrically opposed lower teeth in the second position of the tool.

9. The kitchen appliance of claim 8, wherein the second slot receives the diametrically opposed upper teeth in the second position of the tool.

10. The kitchen appliance of claim 8, wherein the length and width of the first slot are dimensioned to substantially fittingly receive the diametrically opposed upper teeth in the first position of the tool and the diametrically opposed lower teeth in the second position of the tool, such that rotation of the drive shaft effectuates rotation of the tool, and wherein an upper end of the axial extent of the first slot defines a shoulder, whereby the shoulder rests on the upper or lower teeth to axially support the tool in the first or second positions thereof, respectively.

11. The kitchen appliance of claim 8, wherein the length and width of the second slot are dimensioned to receive the diametrically opposed upper teeth, and the axial extent of the second slot is dimensioned to provide sufficient clearance for sliding of the upper teeth therethrough to position the tool in the second position thereof.

12. The kitchen appliance of claim 8, wherein the length and width of the second slot are dimensioned to substantially fittingly receive the diametrically opposed upper teeth.

13. The kitchen appliance of claim 1, wherein an upper end of the drive shaft removably seats into an underside of the lid.

14. The kitchen appliance of claim 13, wherein the lid includes a bushing having an inner bearing surface and the upper end of the drive shaft is removably journaled into the bushing, a base end of the bearing surface being chamfered and the upper end of the drive shaft being rounded for smooth engagement therebetween.

15. The kitchen appliance of claim 1, wherein a size of the apertures of the perforated basket is adjustably dimensioned.

16. The kitchen appliance of claim 1, wherein the rotating tool is a rotating chopping tool.

17. The kitchen appliance of claim 1, wherein the perforated basket is a colander or a sieve.

18. The kitchen appliance of claim 1, wherein the elongate column is integrally formed with the bowl, and extends upwardly from a base end thereof.

19. A kitchen appliance for processing foodstuff comprising:
a housing enclosing a motor;
a bowl removably mounted onto the housing and defining a first cavity therein;
a removable lid to cover at least the bowl;
an apertured basket removably received between the bowl and the lid, the basket having an apertured base end and an apertured skirt sidewall upwardly extending from the base end defining a second cavity,
a drive shaft drivingly coupled with the motor to rotate relative to the housing, the drive shaft extending through the first cavity and extendable into the second cavity;
a tool coupleable with the drive shaft such that rotation of the drive shaft effectuates rotation of the tool, the tool being mountable on the drive shaft within the apertured basket;
wherein apertures of the apertured basket permit foodstuff processed by the tool into fragments smaller than the apertures to pass from the second cavity into the first cavity; and
wherein clearance between the base end or the sidewall of the basket and an adjacent wall of the appliance facing the base end or sidewall is greater than or equal to a greatest dimension of the apertures.

20. The kitchen appliance of claim 19, wherein the tool is mountable on the drive shaft within the apertured basket in a first position and the tool is mountable in a second position on the drive shaft within the bowl; and
wherein, in the first position of the tool, the apertures of the basket permit foodstuff processed by the tool into fragments smaller than the apertures to pass from the second cavity into the first cavity, and in the second position of the tool, foodstuff is processed by the tool directly in the first cavity.

21. The kitchen appliance of claim 19, further comprising an elongate column extending upwardly in the first cavity, the drive shaft extending through the elongate column, and wherein the apertured basket includes a neck projecting downwardly from the base end thereof, the neck being removably keyed with an upper end of the column to removably secure the apertured basket atop the column.

22. The kitchen appliance of claim 19, wherein the apertured basket includes a plurality of angularly spaced apart ribs projecting radially outwardly therefrom, the ribs being dimensioned to engage the underlying bowl to removably support the basket atop the bowl when the perforated basket is received between the bowl and the lid.

23. The kitchen appliance of claim 19, wherein the drive shaft comprises a first drive shaft portion, a shaft adapter and a second drive shaft portion, the shaft adapter and the second drive shaft portion being removably mountable onto the first drive shaft portion and rotationally fixed therewith.

24. The kitchen appliance of claim 23, wherein the first drive shaft portion includes at least one lower tooth projecting laterally therefrom and the second drive shaft portion including at least one upper tooth projecting laterally therefrom and axially spaced upwardly from the at least one lower tooth and at least one shaft adapter tooth laterally projecting from the second drive shaft portion, axially positioned between the at least one upper tooth and the at least one lower tooth and keyed with the adapter shaft, wherein the tool includes a tool spindle removably mountable on the drive shaft, the at least one lower tooth being keyed to the adapter shaft and the tool spindle being keyed to the at least one upper tooth in the first position of the tool and the tool spindle being keyed to the at least one lower tooth in the second position of the tool.
